(19) United States
(12) Patent Application Publication
(10) Pub. No.: US 2012/0020131 A1
(43) Pub. Date: Jan. 26, 2012

(54) POWER APPARATUS AND METHOD OF SUPPLYING POWER

(75) Inventors: Chun-Kong CHAN, Taipei County (TW); Chih-Ping YU, Taipei County (TW)

(73) Assignee: LIEN CHANG ELECTRONIC ENTERPRISE CO., LTD., Taipei County (TW)

(21) Appl. No.: 12/840,591

(22) Filed: Jul. 21, 2010

(51) Int. Cl. H05B 41/36; H02M 7/06

(52) U.S. Cl. 363/126; 315/291

(57) ABSTRACT

The present invention provides a power apparatus, which includes a switch unit, a bleeder resistor, a filter, a rectifier, a power factor corrector, an output capacitor, a rectifying diode, a surge absorber, a main power supply, and a standby power supply. Moreover, the AC power charges to the output capacitor by means of the rectifying diode and the surge arrester, such that the standby power supply generates a standby power while the switch unit is off. Furthermore, the AC power charges to the output capacitor through the switch unit, the bleeder resistor, the filter, the rectifier and the power factor corrector, such that the main power supply generates a main power while the switch unit is on. The present invention further provides a method of supplying power.

### BACKGROUND OF THE INVENTION

1. Field of the Invention

The present invention relates to a particular power apparatus and a particular method for supplying power in order to save energy while the electrical equipment works at standby operating mode.

2. Description of Related Art

In general, electrical equipment is usually configured with a power apparatus and a load, wherein the power apparatus converts the Alternative Current (AC) power to a required power for the load. However, the power apparatus is easily damaged while the end load is destroyed by excessive current generated by surge voltage. For solving this problem, a surge arrester and a fuse are applied in the conventional power apparatus for arresting the surge voltage. Please refer to FIG. 1, in which a block diagram of a conventional power apparatus according to the prior art is demonstrated.

A conventional power apparatus 1 can work for supplying power either at standby operating mode or normal operating mode. While the AC power plug of the electrical equipment plugs into a power socket, an AC transmits into the conventional power apparatus 1 and creates a voltage Vc at a capacitor Co via a fuse 11, a bleeder resistor 13, a filter 12, a surge arrester 10, a rectifier 14, and a diode D1. Meanwhile, a standby power supply 19 generates a standby power (STB power) according to the voltage Vc for supplying power to a load 3. The conventional power supply 1 works at standby operating mode. In view of the aforementioned embodiment, the surge arrester 10 is used to arrest the surge current while the AC power plug of the electrical equipment plugs into the power socket.

In addition, while the switch S1 is on and a power factor corrector 16 is activated, the conventional power apparatus 1 works at the normal operating mode for supplying power. At the same time, the AC transmits into the conventional power apparatus 1 and creates a voltage Vc at the capacitor Co thru the switch S1, the fuse 11, the bleeder resistor 13, the filter 12, the rectifier 14, and the power factor corrector 16. Meanwhile, the main power supply 18 generates a Main power according to the voltage Vc for supplying power to the load 3.

Again, please refer to FIG. 1. The conventional power apparatus 1 works at the standby operating mode, while the AC power plug of the electrical equipment plugs into the power socket, the switch S1 is off, and the power factor corrector 16 has not been activated. At the standby operating mode, the bleeder resistor 13 and the filter 12 of the conventional power apparatus 1 will relatively consume more power; in particular, the filter 12 having resistive elements and capacitive elements consumes great amount power at the standby operating mode. Therefore, the power consumption of the conventional power apparatus 1 at the standby operating mode is not able to meet IEA (International Energy Association) requirement for keep power consumption below 0.1 W for each electrical appliance.

### SUMMARY OF THE INVENTION

The object of the present invention provides a power apparatus, which can effectively arrest a surge current and decrease power consumption at the standby operating mode, thereby achieves the goal of energy saving.

The power apparatus in accordance with certain aspects of the present invention comprises a switch unit, a bleeder resistor, a filter, a rectifier, a power factor corrector, an output capacitor, a rectifying diode, a surge arrester, a main power supply, and a standby power supply. Therein, the switch unit receives an AC and the filter couples to the switch unit thru the bleeder resistor. As the switch unit is on, the filter will filter out the noise signal of the AC. The rectifier, coupled to the filter, receives the rectified AC and outputs a Direct Current (DC). The power factor corrector, coupled to the rectifier, receives the DC and outputs a correction voltage. The output capacitor, coupled to the power factor corrector, receives the correction voltage. The positive terminal of the rectifying diode couples to the AC power. The surge arrester is located between the negative terminal of the rectifying diode and the output capacitor. The main power supply couples to the output capacitor. The standby power supply couples to the output capacitor.

Therein, as the switch unit is off, the AC power creates a standby voltage at the output capacitor through the rectifying diode and the surge arrester, so that the standby power supply is able to generate a standby power; as the switch unit is on, the AC power creates a switch voltage at the output capacitor through the switch unit, the bleeder resistor, the filter, the rectifier, and the power factor corrector, so that the main power supply is able to generate a main power.

The method for supplying power of the present invention, comprises the steps of, turn off a switch unit, and then feed in an AC through a rectifying diode and a surge arrester to create a standby voltage at the output capacitor; turn on the switch unit and activate the power factor corrector; transmit the AC into the power factor corrector through the switch unit, a bleeder transistor, a filter, and a rectifier; create a switching voltage at the output capacitor.

Therefore, through the aforementioned technical proposal of the present invention, the following efficacy would be easily achieved: a. Due to modifying the circuit schematic design, the power consumption would be reduced and the objective of energy saving would be attained during the standby operating mode. b. The goal of “fast boot” would be achieved with the advantages of low input current and fast accumulating of appropriate switching voltage, while the machine is booting.

In order to have further understanding of the present invention, the following embodiments are provided along with illustrations to facilitate the disclosure of the present invention.

### BRIEF DESCRIPTION OF THE DRAWINGS

FIG. 1 illustrates a block diagram of a conventional power apparatus.

FIG. 2 illustrates a power apparatus circuit block diagram of a present invention embodiment;

FIG. 3A illustrates the first flow chart of the method for supplying power of a current invention embodiment;

FIG. 3B illustrates the second flow chart of the method for supplying power of a current invention embodiment; and

FIG. 3C illustrates the third flow chart of the method for supplying power of a current invention embodiment.

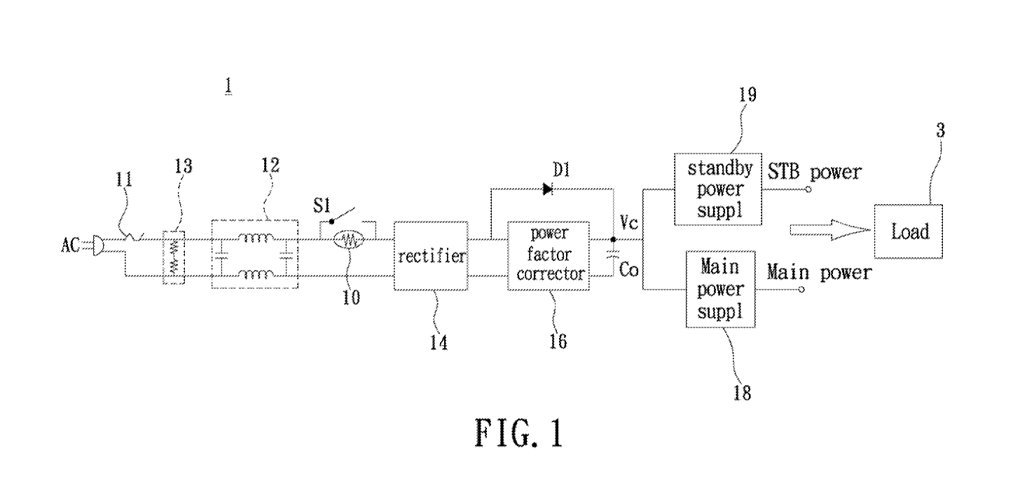

### DETAILED DESCRIPTION OF THE PREFERRED EMBODIMENTS

The aforementioned illustrations and the following detailed descriptions are examples for the purpose of further explaining the scope of the present invention. Other objectives and advantages related to the present invention will be illustrated in the subsequent descriptions and appended drawings.

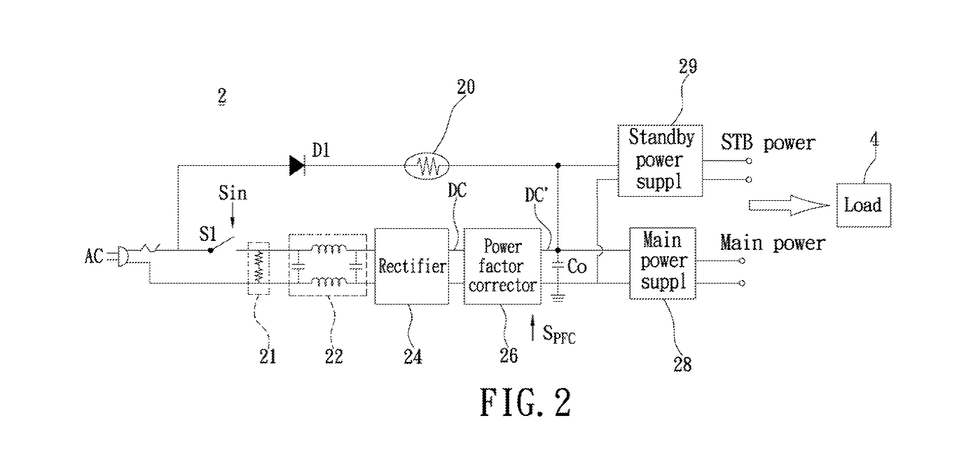

Please refer to FIG. 2, in which a power apparatus circuit block diagram of a present invention embodiment. The power apparatus 2 can be installed inside an electronic device (not shown) to provide electrical power to a load 4 of the electronic device. The electronic device may be a thin TV screen monitor or other screen type monitors. The load 4 may be a LED drive circuit.

Again, refer to FIG. 2, while the plug of the electrical equipment plugs into the power socket, the AC with surge currents would be transmitted into the power apparatus 2 of the present invention embodiment. Therefore, the power apparatus 2 may effectively arrest the surge current to protect the end load 4 and provide a standby power (STB power) to the load 4 at the standby operating mode. Additionally, the power apparatus 2 is controlled by a switching control signal Sin and a power factor correction control signal S_{PFC} to provide a main power (Main power) to the load 4.

As shown in FIG. 2, the power apparatus 2 includes a switch unit S1, a bleeder resistor 21, a filter, 22, a rectifier 24, a power factor corrector 26, an output capacitor Co, a rectifying diode D1, a surge arrester 20, a main power supply 28, and a standby power supply 29. Herein, the positive terminal of the rectifying diode D1 couples to the AC power. The surge arrester 20 is located between the negative terminal of the rectifying diode D1 and the output capacitor Co. The standby power supply 29 couples to the output capacitor Co.

In view of aforementioned illustrations, the surge arrester 20 may be a thermistor or a Negative Temperature Coefficient (NTC). The filter 22 would be an Electromagnetic Interference (EMI) filter or other kinds of filters such as Type II filter which can filter out the noise signals of AC. The rectifier 24 would be a bridge rectifier or other kinds of rectifiers which can convert AC to DC.

As shown in FIG. 2, while the plug of the electrical equipment plugs into the power socket and the switch unit 51 is off, the AC with a surge current may be transmitted into the power apparatus 2. However, the surge current might be arrested or suppressed by the surge arrester 20 inside the power apparatus 2 without damaging the end load 4.

Moreover, as the electrical plug of the electrical equipment stays plugging into the power socket, the switch unit 51 is off, and the electronic device is at the standby operating mode, the AC power passes through the rectifying diode D1 and the surge arrester 20 to charge the output capacitor Co to create a standby voltage at the output capacitor Co. The standby power supply 29 produces the standby power (STB power) in accordance with the standby voltage of the output capacitor Co.

As per the aforementioned embodiment, at the standby operating mode, the AC power charges the output capacitor Co through the charging path which contains the rectifying diode D1 and the surge arrester 20. Since the charging path doesn't contain any high power consuming filters 22 and power factor correctors 26, the power apparatus 2 consumes the standby power minor than 0.1 W.

As shown in FIG. 2, the electrical plug of the electrical equipment plugs into the electrical power socket, the switch unit 51 is conducted and the power factor corrector 26 is activated, the electrical equipment is at the normal operating mode. Meanwhile, the AC power charges the output capacitor Co by means of the switch unit 51, the bleeder resistor 21, the filter 22, the rectifier 24, and the power factor corrector 26, thereby building up a switching voltage at the output capacitor Co.

As per the aforementioned embodiment, the filter 22, coupled to the switch unit 51 thru the bleeder resistor 21, filters out the noise signals of the AC power. The rectifier 24, coupled to the filter 22, receives the rectified AC and outputs a DC. The power factor corrector 26, coupled to the rectifier 24 and the output capacitor Co, receives the DC and outputs a correction voltage DC' to charge the output capacitor Co, so that the switching voltage would be created at the output capacitor Co. At the same time, the main power supply 28 generates the main power (Main power) based on the switching voltage of the output capacitor Co.

As shown in FIG. 2, if the output capacitor Co having standby voltage, the switch unit S1 being conducted by the switching control signal Sin and the power factor corrector 26 being activated by the power factor correction control signal S_{PFC}, the AC power would charge the output capacitor Co via the switch unit S1, the bleeder resistor 21, the filter 22, the rectifier 24, and the power factor corrector 26, so that the voltage of the output capacitor Co might boost from the standby voltage up to the switching voltage. Because the standby voltage is maintained at the output capacitor Co, the input current passing thru the switch unit S1, the bleeder resistor 21, the filter 22, the rectifier 24, and the power factor corrector 26 is relatively low. Consequently, the switching voltage of the output capacitor Co is accumulated very fast, so that the output capacitor Co triggers the main power supply 28 to efficiently generate the main power (Main power), thereby promoting the boot speed of the electronic device.

Therefore, the power apparatus 2 of the embodiment compared to the conventional power apparatus 1, the following efficacies are achieved: a. Due to modifying the circuit schematic design, the power consumption would be reduced and the objective of energy saving would be attained during the standby operating mode. b. The goal of “fast boot” would be achieved with the advantages of low input current and fast accumulating of appropriate switching voltage, while the machine is booting.

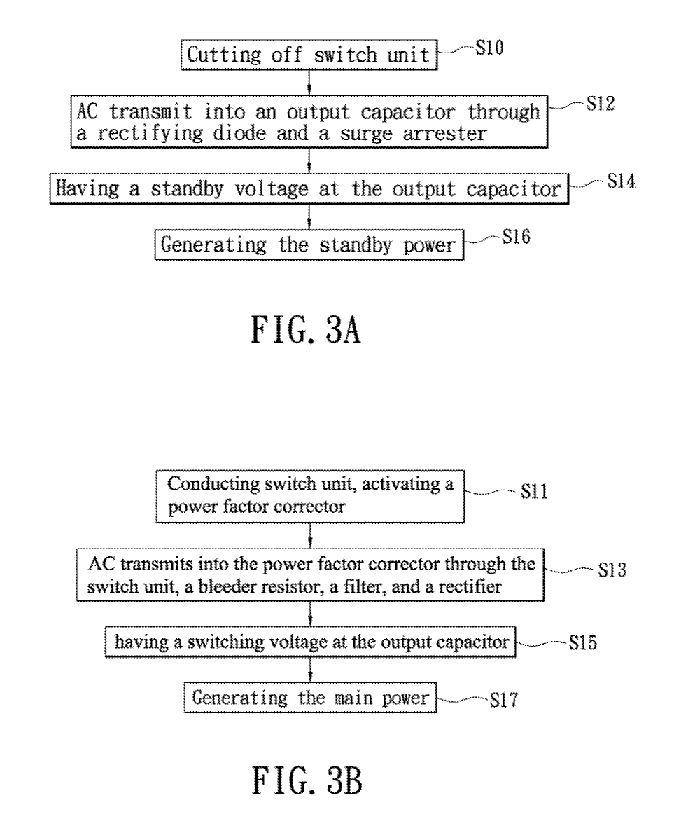

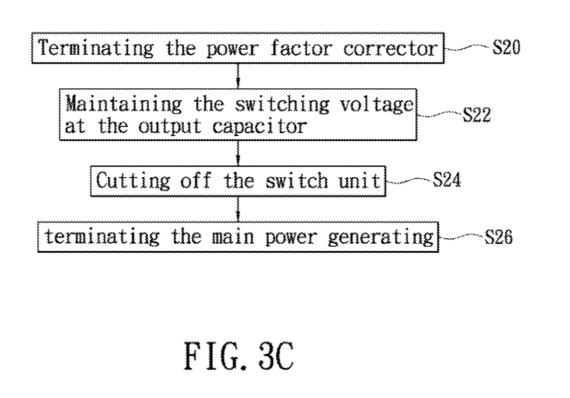

Please refer to FIG. 3A in conjunction with FIG. 2, in which a flow chart of the embodiment of the power apparatus in accordance with certain aspects of the present technique is demonstrated. The method of supplying power is adapted for generating the standby power (STB power) executed by the aforementioned power apparatus 2. The switch unit S1 is in a cutoff state as shown in step S10. Then, when the electrical plug of the electronic device connects to the electrical power receptacle, the AC power which contains the surge current may be transmitted into the power apparatus 2 and simultaneously the surge current is arrested and suppressed by the surge arrester 20. Moreover, the AC power which contains the surge current may charge the output capacitor Co in step S12 through the rectifying diode D1 and the surge absorber 20, thereby creating the standby voltage at the output capacitor Co in step S14. Eventually, according to the standby voltage, the standby power supply 29 produces the standby power (STB power) in step S16.

Please refer to FIG. 3B in conjunction with FIG. 2, in which another flow chart of the embodiment of the power apparatus in accordance with certain aspects of the present technique is demonstrated. The method of supplying power is adapted for generating the main power (Main power) executed by the aforementioned power apparatus 2. The switch unit S1 is conducted and the power factor corrector 26 is activated in step S11. Then the AC power passes thru the switch unit S1, the bleeder resistor 21, the filter 22, and the rectifier 24 into the power factor corrector 26 in step S13. Because the standby voltage of the output capacitor Co is existed, the output current passed though the switch unit S1, the bleeder resistor 21, the filter 22, the rectifier 24, and the power factor corrector 26 is relatively low, thereby preventing unnecessary power consumption.

Consequently, after the activation of the power factor corrector 26, the switching voltage of the output capacitor Co is created in step S15. Because the standby voltage of the output capacitor Co is already existed, the switching voltage can be easy and fast attained. Eventually, according to the switching voltage, the main power supply 28 produces the main power (Main power) in step S17.

Please refer to FIG. 3C in conjunction with FIG. 2, in which yet another flow chart of the embodiment of the power apparatus in accordance with certain aspects of the present technique is demonstrated. The method of supplying power executed by the aforementioned power apparatus 2 is adapted for terminating the main power (Main power) generating. The power factor corrector 26 stops functioning in step S20. At the moment, the output capacitor Co still maintains higher switching voltage in step S22, in which the switching voltage of the output capacitor Co is utilized to block the AC transmitting into the output capacitor Co by ways of the rectifying diode S1 and the surge arrester 20. In step S24, the switch unit S1 is off for terminating the AC feeding into the power factor corrector 26 by ways of the switching unit S1, the bleeder resistor 21, the filter 22, and the rectifier 24. Hence, the switching voltage of the output capacitor Co is down to the standby voltage. Eventually, the main power supply 28 stops to generate the main power (Main power) in step S26.

As per the aforementioned embodiments, the following efficacy of the present technical proposal of the power apparatus 2 is further achieved: at the standby operating mode, by modifying of the circuit schematic design, the standby power consumption is reduced, thereby the objective of power saving is attained. At the normal operating mode of supplying power, as the input current is low and the appropriate switching voltage level is accumulated faster, thereby achieving the purpose of “fast boot”.

It should be noted that, however, the aforementioned texts illustrate merely the detailed descriptions and appended drawings of the present invention, rather than being intended to restrict the scope of the present invention thereto. The scope of the present invention should be based on the following claims, and all changes, alternations or substitutions conveniently considered by those skilled ones in the art in the field of the present invention should be deemed as being encompassed by the scope of the present invention delineated in the claims as below.

What is claimed is:

1. A power apparatus, comprising:
a switch unit, coupled to an AC power;
a filter, coupled to a switch unit thru a bleeder resistor, filtering out the noise signal of the AC while the switch unit is conducted;
a rectifier, coupled to the filter, for receiving the AC being filtered and output a DC;
a power factor corrector, coupled to the rectifier, for receiving the DC and outputting a correction voltage;
an output capacitor, coupled to the power factor corrector, for receiving the correction voltage;
a rectifying diode, having a positive terminal and a negative terminal, in which the positive terminal of the rectifying diode connects to the AC power;
a surge arrester, located between the negative terminal of the rectifying diode and the output capacitor;
a main power supply, coupled to the output capacitor; and
a standby power supply, coupled to the output capacitor;
wherein as the switch unit is cut off, the AC power passes thru the rectifying diode and the surge arrester to build up a standby voltage at the output capacitor, so that the standby power supply generates a standby power; as the switching power is conducted, the AC passes thru the bleeder resistor, the filter, the rectifier, and the power factor corrector to build up a switching voltage at the output capacitor, so that the main power supply generates a main power.

2. The power apparatus according to claim 1, wherein the surge arrester is a thermistor.

3. The power apparatus according to claim 1, wherein the standby power supply supplies the main power to a LED drive circuit.

4. A method of supplying power, comprising:
cutting off a switch unit;
feeding a AC through a rectifying diode and a surge arrester to build up a standby voltage at an output capacitor;
conducting the switch unit;
transmitting the AC through the switching unit, a bleeder resistor, a filter, and a rectifier into a power factor corrector; and
activating the power factor corrector to build up a switching voltage at the output capacitor.

5. The method of supplying power according to claim 4, further including utilizing a standby power supply to receive the standby voltage and generate a standby power.

6. The method of supplying power according to claim 5, further including utilizing a main power supply to receive the switching voltage and generate a main power.

7. The method of supplying power according to claim 6, further including:
terminating the power factor corrector, while the switch unit is conducted;
utilizing the switching voltage at the output capacitor to block the AC power passing into the output capacitor thru the rectifying diode and the surge arrester; and
controlling the switch unit to be cut off so as to prevent the AC transmit into the power factor corrector thru the switch unit, the bleeder resistor, the filter, and the rectifier.

8. The method of supplying power according to claim 7, further including terminating the main power supply to generate the main power.

9. The method of supplying power according to claim 7, wherein the surge arrester is a thermistor.

10. The method of supplying power according to claim 7, wherein the standby power supply provides the main power to a LED drive circuit.
